(19) United States
(12) Patent Application Publication
(10) Pub. No.: US 2021/0073634 A1
(43) Pub. Date: Mar. 11, 2021

(54) SERVER AND CONTROL METHOD THEREOF

(71) Applicant: Samsung Electronics Co., Ltd., Suwon-si (KR)

(72) Inventors: Geunsik LIM, Suwon-si (KR); Myungjoo HAM, Suwon-si (KR); Jaeyun JUNG, Suwon-si (KR)

(21) Appl. No.: 17/013,375

(22) Filed: Sep. 4, 2020

(30) Foreign Application Priority Data
Sep. 5, 2019 (KR) 10-2019-0110007

(51) Int. Cl. G06N 3/08; G06F 8/40

(52) U.S. Cl. CPC G06N 3/08; G06F 8/40

(57) ABSTRACT

A server is provided. The server according to the disclosure includes a memory and a processor. The processor is configured to obtain input data to be input to a trained neural network model using a peripheral device handler, obtain output data by inputting the obtained input data to the trained neural network model via a virtual input device generated by the peripheral device handler, store the output data in a memory area assigned to a virtual output device generated by the peripheral device handler, and verify the neural network model based on the output data stored in the memory area assigned to the virtual output device.

### CROSS-REFERENCE TO RELATED APPLICATIONS

This application is based on and claims priority under 35 U.S.C. § 119(a) of a Korean Patent Application No. 10-2019-0110007, filed on Sep. 5, 2019, in the Korean Intellectual Property Office, the disclosure of which is incorporated by reference herein in its entirety.

### BACKGROUND

### 1. Field

The disclosure relates to an artificial intelligence (AI) system using a machine learning algorithm and application.

### 2. Description of the Related Art

An artificial intelligence system is a computer system for realizing human intelligence, in which a machine trains and determines itself and a recognition rate is improved as the system is used.

In recent years, on-device artificial intelligence (AI) applications for learning and predicting information received using a camera and a microphone by deep learning have been increased. The on-device AI is able to execute a deep neural network model directly on a device of a user, and demands for the on-device AI have been increased to solve problems such as security vulnerability of personal information due to network communication between a cloud and a user device, communication delay due to network disconnection, cloud operation cost increase, and the like.

If a code with respect to the on-device AI is modified, it is necessary to perform a verification process of analyzing whether this affects the existing operation. In the related art, when performing the verification for the on-device AI on a server, the verification for the on-device AI was performed by connecting embedded devices to a physical server via USB ports. In a case of performing the verification for the on-device AI by connecting the embedded device directly to the server as in the related art, problems such as limited number of devices physically mountable on the server and excessively high operation cost might occur.

In addition, attempts for performing the execution and verification for the on-device AI on a virtual machine instance in a cloud environment have been increased. The virtual machine instance in the cloud environment is an OS based on virtual machine, and in the related art, there was no method for providing a virtual peripheral device for executing verification for the on-device AI on the virtual machine instance in the cloud. Thus, needs for methods for providing a virtual peripheral device for performing execution and verification for the on-device AI on the virtual machine instance in the cloud environment have been increased.

### SUMMARY

The disclosure has been made based on the above problems and an object of the disclosure is to provide a server capable of executing and verifying an on-device AI without physical device connection during execution and verification for the on-device AI based on a cloud, and a method for controlling the same.

According to an aspect of the disclosure for achieving the afore-mentioned object, there is provided a method for controlling a server, the method including, obtaining input data to be input to a trained neural network model using a peripheral device handler, obtaining output data by inputting the obtained input data to the trained neural network model via a virtual input device generated by the peripheral device handler, storing the output data in a memory area assigned to a virtual output device generated by the peripheral device handler, and verifying the neural network model based on the output data stored in the memory area assigned to the virtual output device.

According to another aspect of the disclosure for achieving the afore-mentioned object, there is provided a server including a memory including at least one instruction, and a processor connected to the memory and configured to control the server, in which the processor, by executing the at least one instruction, is configured to obtain input data to be input to a trained neural network model using a peripheral device handler, obtain output data by inputting the obtained input data to the trained neural network model via a virtual input device generated by the peripheral device handler, store the output data in a memory area assigned to a virtual output device generated by the peripheral device handler, and verify the neural network model based on the output data stored in the memory area assigned to the virtual output device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a server according to an embodiment;

FIG. 2 is a block diagram illustrating a configuration of a server according to an embodiment;

FIG. 3 is a view illustrating a virtual input device according to an embodiment;

FIG. 4 is a view illustrating a plurality of virtual output devices according to an embodiment;

FIG. 5 is a view illustrating a method for verifying a neural network model via virtual output devices according to an embodiment;

FIG. 6 is a view illustrating a process of performing verification for the neural network model according to an embodiment;

FIG. 7 is a view illustrating a neural network model execution environment model according to an embodiment; and

FIG. 8 illustrates a flowchart for verifying the neural network model according to an embodiment.

### DETAILED DESCRIPTION

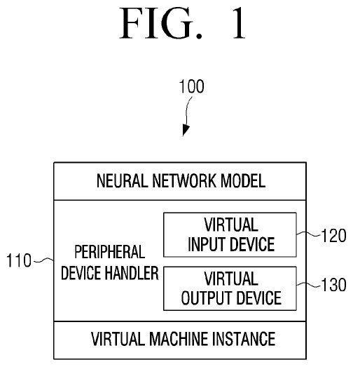

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the disclosure will be described in more detail with reference to the drawings.

FIG. 1 is a view illustrating a server 100 according to an embodiment of the disclosure.

A verifying process of a neural network model according to the disclosure may be implemented with a virtual machine instance.

The virtual machine instance may refer to a virtual server in a cloud.

The server 100 according to the disclosure may include a peripheral device handler 110, a virtual input device 120, and a virtual output device 130.

The peripheral device handler 110 is a component for controlling the virtual input device 120 and the virtual output device 130 to execute or verify a neural network model on a virtual machine instance of a cloud in which an external device such as a microphone, a camera, or an audio device does not exist.

The peripheral device handler 110, the virtual input device 120, and the virtual output device 130 may be implemented as at least one software.

Output data may be obtained by inputting an input data to a trained neural network model using the peripheral device handler 110.

The neural network model according to the disclosure may be an on-device neural network model and the on-device neural network model may be implemented with a deep learning framework.

In other words, before the trained and verified on-device neural network model is used on a device of a user, the server 100 may execute the trained on-device neural network model or verify the trained on-device neural network model.

The server 100 may verify the trained on-device neural network model without physical connection with an external device using the peripheral device handler 110 according to the disclosure.

The peripheral device handler 110 may obtain the input data to be input to the trained neural network model.

For example, the peripheral device handler 110 may obtain the input data by a streaming method from the outside of the server 100.

However, there is no limitation thereto and data in a local portion of the server 100 may be obtained by a streaming method.

The input data may include first data including an image, second data including a text, and third data including a sound.

When the input data is obtained, the server 100 may identify a type of the input data.

In other words, the server 100 may identify whether the input data is the first data including an image, the second data including a text, or the third data including a sound.

The server 100 may obtain the output data by inputting the input data to the trained neural network model via the virtual input device 120 corresponding to the identified type.

The virtual input device 120 may be generated (created) by the peripheral device handler 110 as a component for inputting the input data to the neural network model, even if the server 100 is not connected to an external device such as a camera or a microphone.

In other words, the virtual input device 120 may include a first virtual input device for inputting the first data to the neural network model, a second virtual input device for inputting the second data to the neural network model, and a third virtual input device for inputting the third data to the neural network model.

For example, if the input data is identified as the first data including an image, the server 100 may input the first data to the trained neural network model via the first virtual input device.

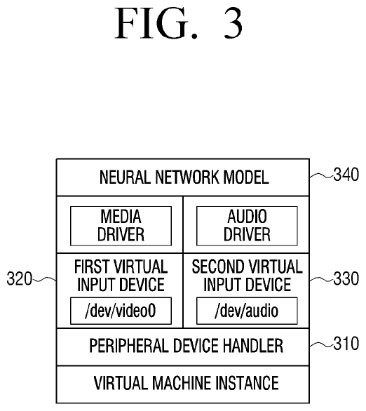

The virtual input device 120 will be described in detail with reference to FIG. 3.

When the output data is obtained from the neural network model, the server 100 may store the output data in a memory area assigned to the virtual output device 130 created by the peripheral device handler 110.

Even if the server 100 is not connected to an external device such as a display, the neural network model may be verified based on the output data stored in the memory area assigned to the virtual output device 130.

In other words, the server 100 may identify whether or not the neural network model is executed without any errors without physical connection to an external device, using the output data stored in the memory area assigned to the virtual output device 130.

In other words, according to the disclosure, the execution and the verification of the neural network model may be performed in the virtual machine instance of the cloud using the peripheral device handler 110 without an actual external device such as a camera and a microphone.

In addition, the execution and the verification of the neural network model may be performed in the virtual machine instance environment of the cloud through the above process, without a technology for generating performance overhead such as virtual machine and simulator.

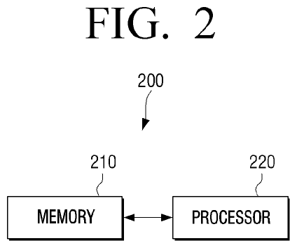

FIG. 2 is a block diagram illustrating a configuration of a server according to an embodiment of the disclosure.

Referring to FIG. 2, a server 200 may include a memory 210 and a processor 220.

The components illustrated in FIG. 2 are examples for implementing the embodiments of the disclosure and suitable hardware/software components which are apparent to those skilled in the art may be additionally included in the server 200.

The memory 210 may store an instruction or data related to at least another component of the server 200.

The memory 210 may be accessed by the processor 220 and reading, recording, editing, deleting, or updating of the data by the processor 220 may be executed.

A term memory in the disclosure may include the memory 210, a ROM (not shown) or a RAM (not shown) in the processor 220, or a memory card (not shown) (e.g., a micro SD card or a memory stick) mounted on the server 200.

The output data of the neural network model may be stored in an area of the memory 210 assigned to each virtual output device of the memory 210.

For example, the virtual output device may be assigned to each neural network model for verification and the output data output from the neural network model may be stored in the area of the memory 210 assigned to each virtual output device.

A function related to the artificial intelligence according to the disclosure may be operated through the processor 220 and the memory 210.

The processor 220 may include one or a plurality of processors.

The one or the plurality of processors may be a general-purpose processor such as a central processing unit (CPU) or an application processor (AP), a graphic dedicated processor such as graphics-processing unit (GPU) or a visual processing unit (VPU), or an artificial intelligence processor such as a neural processing unit (NPU), or the like.

The one or the plurality of processors may perform control to process the input data according to a predefined action rule stored in the memory or a neural network model.

The predefined action rule or the neural network model is formed through training.

The forming through training herein may refer, for example, to forming a predefined action rule or a neural network model having a desired feature by applying a training algorithm to a plurality of pieces of learning data.

Such training may be performed in a device demonstrating artificial intelligence according to the disclosure or performed by a separate server or system.

The neural network model may include a plurality of neural network layers.

The plurality of neural network layers have a plurality of weight values, respectively, and execute processing of layers through a processing result of a previous layer and processing between the plurality of weights.

The neural network may include, for example, a convolutional neural network (CNN), deep neural network (DNN), recurrent neural network (RNN), restricted Boltzmann machine (RBM), deep belief network (DBN), bidirectional recurrent deep neural network (BRDNN), deep Q-network, or the like, but there is no limitation to these examples, unless otherwise noted.

The processor 220 may be electrically connected to the memory 210 and generally control operations of the server 200.

For example, the processor 220 may control the server 200 by executing at least one instruction stored in the memory 210.

According to the disclosure, the processor 220 may obtain the input data to be input to the trained neural network model using the peripheral device handler by executing the at least one instruction stored in the memory 210.

For example, the processor 220 may obtain the input data using the peripheral device handler from the outside of the server 200 by a streaming device.

The processor 220 may obtain the output data by inputting the input data obtained via the virtual input device created by the peripheral device handler to the trained neural network model.

Specifically, the processor 220 may identify the type of the obtained input data, and obtain the output data by inputting the input data obtained via the virtual input device corresponding to the identified type to the trained neural network model.

Specifically, the peripheral device handler may provide a device node file to the virtual input device corresponding to the identified type and the virtual input device may input the input data to the neural network model based on the device node file.

Examples of the type of the input data may include first data including an image, second data including a text, and third data including a sound.

However, there is no limitation thereto, and any type of data which is able to be input to the neural network model such as data including GPS information may be included.

The processor 220 may store the output data output from the neural network model in an area of the memory 210 assigned to the virtual output device created by the peripheral device handler.

For example, the virtual output device may include a plurality of virtual output devices according to the type of the neural network model.

In other words, if the number of neural network models for performing the verification is more than one, a plurality of virtual output devices corresponding to a plurality of neural network models may be created by the peripheral device handler.

The processor 220 may identify the virtual output device corresponding to the neural network model, which has output the output data, and may store the output data in a memory area assigned to the identified virtual output device.

The processor 220 may verify the neural network model based on the output data stored in the memory area assigned to the virtual output device.

For example, the processor 220 may verify the neural network model by identifying an execution result regarding the neural network model corresponding to the virtual output device using the output data stored in the memory area assigned to the virtual output device.

FIG. 3 is a view illustrating a virtual input device according to an embodiment of the disclosure.

According to the disclosure, the verification process of the neural network model may be implemented on a virtual machine instance of the server.

The virtual input device according to the disclosure may be a virtual device based on a loopback device, and a media driver, an audio driver, and a microphone driver may be operated by a virtual input device which is not an actual physical device but is a virtual device based on input and output on the memory.

Specifically, if a peripheral device handler 310 obtains image data, the peripheral device handler 310 may provide a video device node file (/dev/video) to a first virtual input device 320 to input the image data to a neural network model 340.

The first virtual input device 320 may input the image data to the neural network model 340 using the video device node file through the media driver.

If the peripheral device handler 310 obtains audio data, the peripheral device handler 310 may provide an audio device node file (/dev/video) to a second virtual input device 330 to input the audio data to the neural network model 340.

The second virtual input device 330 may input the audio data to the neural network model 340 using the audio device node file through the audio driver.

FIG. 3 illustrates that two virtual input devices exist, but there is no limitation thereto, and more virtual input devices may exist according to the type of the data which is able to be input to the neural network model.

The neural network model trained through the above process may be a neural network model trained by receiving the input data in real time.

By executing the trained neural network model, the verification for the trained neural network model may be performed.

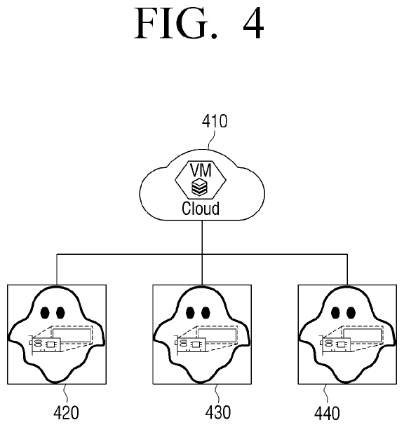

FIG. 4 is a view illustrating a plurality of virtual output devices according to an embodiment of the disclosure.

Referring to FIG. 4, the virtual output device may include a plurality of virtual output devices 420 to 440 according to the number of neural network models.

Specifically, the virtual output device may include a first virtual output device 420 corresponding to a first neural network model, a second virtual output device 430 corresponding to a second neural network model, and a third virtual output device 440 corresponding to a third neural network model.

FIG. 4 illustrates three virtual output devices, but there is no limitation thereto, and the number of virtual output devices corresponding to the number of neural network models may be provided.

A server 410 according to the disclosure may be implemented as a virtual machine instance.

When the output data is obtained from the neural network model, the server 410 may identify the virtual output device corresponding to the neural network model, which has output the output data, and store the output data in a memory area assigned to the identified virtual output device.

Specifically, first output data obtained from the first neural network model may be stored in a memory area assigned to the first virtual output device 420 corresponding to the first neural network model.

In addition, second output data obtained from the second neural network model may be stored in a memory area assigned to the second virtual output device 430 corresponding to the second neural network model.

According to an embodiment of the disclosure, the memory area assigned to the virtual output device may be accessed by a neural network model different from the neural network model corresponding to the virtual output device.

For example, the memory area assigned to the first virtual output device may be accessed by a second or third neural network model which is different from the first neural network model corresponding to the first virtual output device.

As described above, the output data obtained from the neural network model may be stored in the memory area assigned to the virtual output device corresponding to the neural network model, and the verification for the neural network model may be performed.

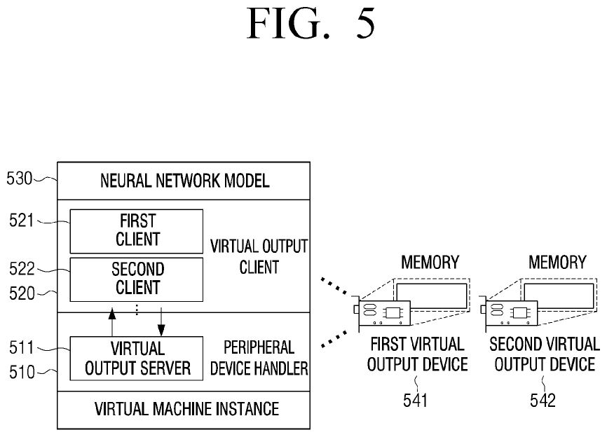

FIG. 5 is a view illustrating a method for verifying the neural network model via virtual output devices according to an embodiment of the disclosure.

According to an embodiment of the disclosure, a verification result of the neural network model may be identified using a virtual output client 520 corresponding to the virtual output device.

The virtual output client 520 may exist by the number corresponding to the neural network models.

The verification result of the first neural network model may be identified using a first client 521 corresponding to the first neural network model.

In other words, the first client 521 may access the memory area assigned to a first virtual output device 541 corresponding to the first neural network model and identify the verification result of the first neural network model.

Specifically, the virtual output client may create a virtual service port and may access the memory area assigned to the virtual output device via the service port.

A virtual output server 511 included in a peripheral device handler 510 may be connected to the first and second clients included in the virtual output client 520 by TCP/IP method, and the first and second clients may access the memory area assigned to the virtual output device.

Accordingly, the first client 521 may perform reading with respect to data stored in the memory area assigned to the first virtual output device 541 and a second client 522 may perform reading with respect to data stored in the memory area assigned to a second virtual output device 542, thereby minimizing and/or reducing operation delay of the server.

In other words, it is possible to prevent loads to the IO of the server and network through the 1:N model structure of the peripheral device handler and the virtual output clients described above.

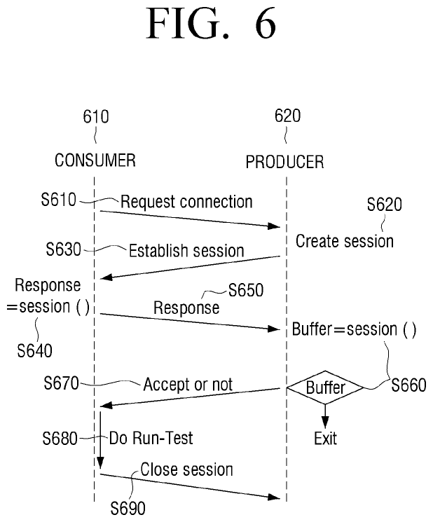

FIG. 6 is a view illustrating a process of performing the verification for the neural network model according to an embodiment of the disclosure.

FIG. 6 illustrates an embodiment showing a process for performing the verification for the plurality of neural network models.

When the server according to the disclosure verifies or executes the plurality of neural network models, a consumer corresponding to each of the plurality of neural network models and one producer may be connected to each other by TCP/IP method to perform the verification for the neural network model.

A consumer 610 illustrated in FIG. 6 may correspond to the virtual output client 520 illustrated in FIG. 5, and a producer 620 may correspond to the peripheral device handler 510 illustrated in FIG. 5.

That is, when executing and verifying the plurality of neural network models on the server, a model of the producer and consumers may be provided in an operation structure of 1:N, and the execution and verification for the neural network models may be performed by generating network ports based on TCP/IP.

With the model of the producer and consumers, N consumers (virtual output clients) may perform reading, and accordingly, no cost is required for synchronization and an execution environment for minimizing and/or reducing the operations of the producer may be provided.

Specifically, the consumer 610 may request the producer 620 for connection (S610), and the producer may create a session (S620) to be connected to the consumer 610 and transmit an established session to the consumer 610 (S630).

When the session is established, the consumer 610 may generate a response to the established session (S640) and transmit the response to the producer 620 (S650), and the producer 620 may determine an operation of the neural network model corresponding to the consumer 610 based on the data stored in the memory area assigned to the virtual output device corresponding to the consumer 610 (S660).

Then, the producer may transmit the operation (Accept or not) of the neural network model to the consumer 610 (S670).

The consumer 610 may inspect whether or not the neural network model is able to be normally executed (S680) and transmit a response for notifying a close of the session to the producer 620 (S690).

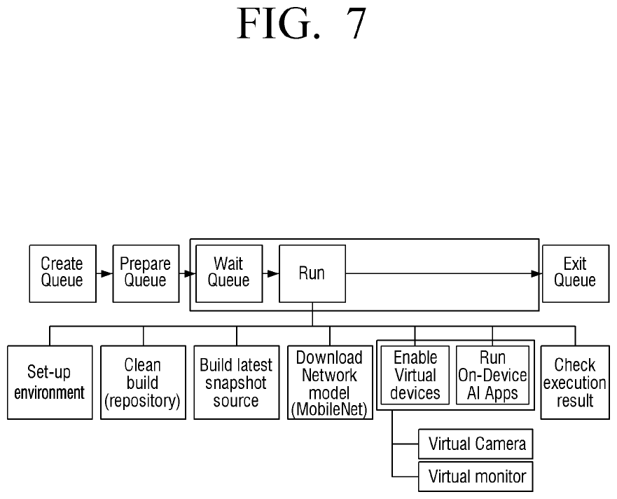

FIG. 7 is a view illustrating a neural network model execution environment model according to an embodiment of the disclosure.

Referring to FIG. 7, a server manages environment variables to provide an execution environment for the neural network model (Set-up environment).

Specifically, this is a process of controlling a set environment different for each neural network model for performing the verification.

The server 200 may perform clean build with respect to the entire source regarding the neural network model having a modified source code on the virtual machine instance.

The clean build process may be a process of applying the source code modified in the neural network model to the neural network model.

If the build of the source code is performed with respect to the one neural network model several times, the server 200 may identify the latest operation executed as a finally modified source code and apply the finally modified source code to the neural network model (Build latest snapshot source).

The above process is a prepare queue process and is a process of executing necessary operation before performing the verification for the neural network model.

When the prepare queue process is completed, the server 200 proceeds to a wait queue process of identifying the neural network model for performing the verification among the plurality of neural network models applied with the modified source code.

In other words, this is a standby stage before performing the verification for the neural network model and is a stage for limiting the number of neural network models proceeding to a run state which is the next stage to prevent overload on the server 200.

Then, the server 200 may proceed to the run stage for performing the verification for the identified neural network model.

The run stage is a stage for performing actual build and verification for the neural network model and all of the operations in the run state may be managed with a list.

An operation of actually downloading the neural network model applied with the modified source code may be performed at the run stage (Download Network Model).

When downloading the neural network model applied with the modified source code at the run stage, the operations in the standby state may be automatically removed by repeatedly reporting a plurality of code modifications by a developer.

The peripheral device handler may input the input data using a virtual camera which is a virtual input device to the downloaded neural network model, obtain output data from the neural network model, and store the output data in the memory area assigned to a virtual monitor which is a virtual output device corresponding to the neural network model.

Then, the server 200 may verify the neural network model based on the output data stored in the memory area assigned to the virtual output device (Check execution result).

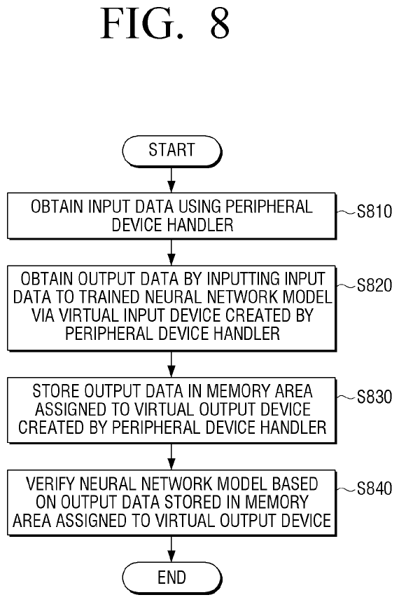

FIG. 8 illustrates a flowchart for verifying the neural network model according to an embodiment of the disclosure.

Referring to FIG. 8, the server 200 may obtain the input data using the peripheral device handler (S810).

Specifically, the server 200 may obtain the input data from the outside of the server 200 using the peripheral device handler by a streaming method.

The server 200 may obtain the output data by inputting the input data to the trained neural network model via the virtual input device created by the peripheral device handler (S820).

Specifically, the server 200 may identify the type of the input data and input the input data to the trained neural network model via the virtual input device corresponding to the identified type.

For example, if the input data is the first data including an image, the first data may be input to the trained neural network model via the first virtual input device corresponding to the first data.

The server 200 may store the output data obtained from the neural network model in the memory area assigned to the virtual output device created by the peripheral device handler (S830).

Specifically, when verifying the plurality of neural network models, the virtual output devices corresponding to the plurality of neural network models may be created by the peripheral device handler.

For example, when the output data is obtained from the first neural network model, the output data may be stored in the memory area assigned to the first virtual output device corresponding to the first neural network model.

The server 200 may verify the neural network model based on the output data stored in the memory area assigned to the virtual output device (S840).

That is, the server 200 may verify the neural network model by identifying an execution result regarding the neural network model corresponding to the virtual output device using the output data stored in the memory area assigned to the virtual output device.

The embodiments described above may be implemented in a recording medium readable by a computer or a similar device using software, hardware, or a combination thereof.

According to the implementation in terms of hardware, the embodiments of the disclosure may be implemented using at least one of Application Specific Integrated Circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

In some cases, the embodiments described in this specification may be implemented as a processor itself.

According to the implementation in terms of software, the embodiments such as procedures and functions described in this specification may be implemented as separate software modules.

Each of the software modules may execute one or more functions and operations described in this specification.

The methods according to the embodiments of the disclosure descried above may be stored in a non-transitory readable medium.

Such a non-transitory readable medium may be mounted and used on various devices.

The non-transitory readable medium is not a medium storing data for a short period of time such as a register, a cache, or a memory, but means a medium that semi-permanently stores data and is readable by a machine.

Specifically, programs for performing the various methods may be stored and provided in the non-transitory readable medium such as a CD, a DVD, a hard disk, a Blu-ray disc, a USB, a memory card, and a ROM.

According to an embodiment, the methods according to various embodiments disclosed in this disclosure may be provided to be included in a computer program product.

The computer program product may be exchanged between a seller and a purchaser as a commercially available product.

The computer program product may be distributed in the form of a machine-readable storage medium (e.g., compact disc read only memory (CD-ROM)) or distributed online through an application store (e.g., Play™).

In a case of the on-line distribution, at least a part of the computer program product may be at least temporarily stored or temporarily generated in a storage medium such as a memory of a server of a manufacturer, a server of an application store, or a relay server.

While preferred embodiments of the disclosure have been shown and described, the disclosure is not limited to the aforementioned specific embodiments, and it is apparent that various modifications can be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for controlling a server, the method comprising:
obtaining input data to be input to a trained neural network model using a peripheral device handler;
obtaining output data by inputting the obtained input data to the trained neural network model via a virtual input device generated by the peripheral device handler;
storing the output data in a memory area assigned to a virtual output device generated by the peripheral device handler; and
verifying the neural network model based on the output data stored in the memory area assigned to the virtual output device.

2. The method according to claim 1, wherein the obtaining using the peripheral device handler comprises obtaining the input data from outside of the server using the peripheral device handler by a streaming method.

3. The method according to claim 1, wherein:
the virtual input device comprises a plurality of virtual input devices corresponding to types of the input data, and
the obtaining output data comprises:
identifying the type of the obtained input data, and
obtaining the output data by inputting the obtained input data to the trained neural network model via a virtual input device corresponding to the identified type.

4. The method according to claim 3, wherein:
the peripheral device handler provides a device node file to the virtual input device corresponding to the identified type, and
the virtual input device inputs the input data to the neural network model based on the device node file.

5. The method according to claim 1, wherein the input data comprises;
first input data including an image;
second input data including a text; and
third data including a sound.

6. The method according to claim 1, wherein:
the virtual output device comprises a plurality of virtual output devices corresponding to types of the neural network models, and
the storing comprises:
identifying a virtual output device corresponding to a neural network model which has output the output data, and
storing the output data in a memory area assigned to the identified virtual output device.

7. The method according to claim 6, wherein the memory area assigned to the virtual output device is accessed by a neural network model different from the neural network model corresponding to the virtual output device.

8. The method according to claim 1, further comprising:
applying a modified source code to at least one neural network model among a plurality of neural network models; and
identifying a neural network model to be verified among a plurality of neural network models applied with the modified source code,
wherein the verifying comprises verifying the identified neural network model.

9. The method according to claim 1, wherein the neural network model is an on-device neural network model.

10. The method according to claim 9, wherein the on-device neural network model is implemented with a deep learning framework.

11. A server comprising:
a memory including at least one instruction; and
a processor connected to the memory and configured to control the server,
wherein the processor, by executing the at least one instruction, is configured to:
obtain input data to be input to a trained neural network model using a peripheral device handler;
obtain output data by inputting the obtained input data to the trained neural network model via a virtual input device generated by the peripheral device handler;
store the output data in a memory area assigned to a virtual output device generated by the peripheral device handler; and
verify the neural network model based on the output data stored in the memory area assigned to the virtual output device.

12. The server according to claim 11, wherein the processor is further configured to obtain the input data from outside of the server using the peripheral device handler by a streaming method.

13. The server according to claim 11, wherein:
the virtual input device comprises a plurality of virtual input devices corresponding to types of the input data, and
the processor is further configured to:
identify the type of the obtained input data; and
obtain the output data by inputting the obtained input data to the trained neural network model via a virtual input device corresponding to the identified type.

14. The server according to claim 13, wherein:
the peripheral device handler provides a device node file to the virtual input device corresponding to the identified type, and
the virtual input device inputs the input data to the neural network model based on the device node file.

15. The server according to claim 11, wherein the input data comprises:
first input data including an image;
second input data including a text; and
third data including a sound.

16. The server according to claim 11, wherein:
the virtual output device comprises a plurality of virtual output devices corresponding to types of the neural network models, and
the processor is further configured to:
identify a virtual output device corresponding to a neural network model which has output the output data, and
store the output data in a memory area assigned to the identified virtual output device.

17. The server according to claim 16, wherein the memory area assigned to the virtual output device is accessed by a neural network model different from the neural network model corresponding to the virtual output device.

18. The server according to claim 11, wherein the processor is further configured to:
apply a modified source code to at least one neural network model among a plurality of neural network models;
identify a neural network model to be verified among a plurality of neural network models applied with the modified source code; and
verify the identified neural network model.

19. The server according to claim 11, wherein the neural network model is an on-device neural network model.

20. The server according to claim 19, wherein the on-device neural network model is implemented with a deep learning framework.
